(19) United States
(12) Patent Application Publication
(10) Pub. No.: US 2009/0183121 A1
(43) Pub. Date: Jul. 16, 2009

(54) IMAGE FORMING APPARATUS

(75) Inventor: Shigeo KONUMA, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/347,299

(22) Filed: Dec. 31, 2008

(30) Foreign Application Priority Data
Jan. 11, 2008 (JP) 2008-004546

(51) Int. Cl. G06F 3/048

(52) U.S. Cl. 715/840

(57) ABSTRACT

An image forming apparatus includes a display section to display an operation screen having a plurality of buttons each of which shows each type of operation instruction, a first input section to input a selecting instruction of at least any one button among the buttons based on a pushed signal on the operation screen, a second input section to input the selecting instruction of the one button by a structure different from the first input section and a control section to make the display section display an operation supporting screen which supports to input the selecting instruction without finalizing an operation instruction indicated by the one button to which the selecting instruction is given when the selecting instruction is input by the first input section in the operation screen which is structured so as to assume that the selecting instruction of the one button is inputted by the second input section.

### BACKGROUND OF THE INVENTION

1. Field of the Invention

The present invention relates to an image forming apparatus.

2. Description of Related Art

In recent years, a touch panel which is provided so as to cover the operation screen which is displayed on the CRT (Cathode Ray Tube) display, the LCD (Liquid Crystal Display) or the like and a, mouse as a pointing device to operate the pointer on the operation screen and carry out an input are widely used as the input device that can be used easily even by a user who is not good at computer operation.

When the touch panel and the mouse are provided as the input device, using of the left button and the right button and the drag operation of the mouse cannot be carried out because the input is carried out by pushing the buttons which are displayed on the operation screen when the input operation is to be carried out by the touch panel.

In JP2007-226571, techniques such that a pointer is displayed at a position contacting the touch panel when carrying out an operation of the touch panel, a, selecting menu to execute operations such as left click, right click, dragging and the like by a mouse is displayed at a position adjacent to the pointer, and an operation similar to the mouse can be carried out by selecting from the selecting menu are disclosed.

In the operation screen which is structured based on the operation by a touch panel as standard operation, size of the button to be displayed is restricted to the size which can be easily pushed not allowing a plurality of buttons to be displayed and complicated operations to be carried out. On the other hand, in the operation screen which is structured based on the operation by a mouse as standard operation, there is no reason that the size of the button to be display to be restricted and a plurality of buttons can be displayed and complicated operations can be carried out. Further, there is an advantage that not only it is convenient for an able-bodied person but also convenient for a person who is disabled in his or her hands and fingers.

Moreover, when the image forming apparatus is provided with a touch panel and a mouse as input device, the touch panel is provided at an upper part of the main body of the image forming apparatus so as to be parallel to the floor in many cases. In such case, there is a problem for a user who is in wheelchair or the like that the touch panel is hard to reach and the operation is difficult, however, the mouse becomes an alternative to the operation by the mouse.

However, when the operation similar to the operation by mouse is realized by the touch panel in the operation screen which is structured based on the operation by the mouse as standard operation, it is difficult to select a button in a size smaller than finger tip and there is a problem that the operation is inconvenient because error operations can occur.

### SUMMARY OF THE INVENTION

In view of the above problem, an object of the present invention is to provide an image forming apparatus which can prevent error operation due to the touch panel and which can improve the operability.

To achieve at least one of the abovementioned objects, an image forming apparatus comprises a display section to display an operation screen having a plurality of buttons each of which shows each type of operation instruction, a first input section to input a selecting instruction of at least any one button among the buttons based on a pushed signal on the operation screen, a second input section to input the selecting instruction of the one button by a structure different from the first input section and a control section to make the display section display an operation supporting screen which supports to input the selecting instruction without finalizing an operation instruction indicated by the one button to which the selecting instruction is given when the selecting instruction is input by the first input section in the operation screen which is structured so as to assume that the selecting instruction of the one button is inputted by the second input section.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a schematic cross-sectional structure diagram of an image forming apparatus;

FIG. 2 is a control block diagram of the image forming apparatus;

FIG. 3 is a flowchart of an operation supporting process;

FIG. 4 is a flowchart of the operation supporting process (continuation of FIG. 3);

FIG. 5 is a diagram showing an example of an operation screen and an operation supporting screen in step S5; and

FIG. 6 is a diagram showing an example of an operation screen and an operation supporting screen in step S13.

### DESCRIPTION OF THE PREFERRED EMBODIMENTS

Hereinafter, an embodiment of the present invention will be described in detail with reference to the drawings.

First, the structure will be described.

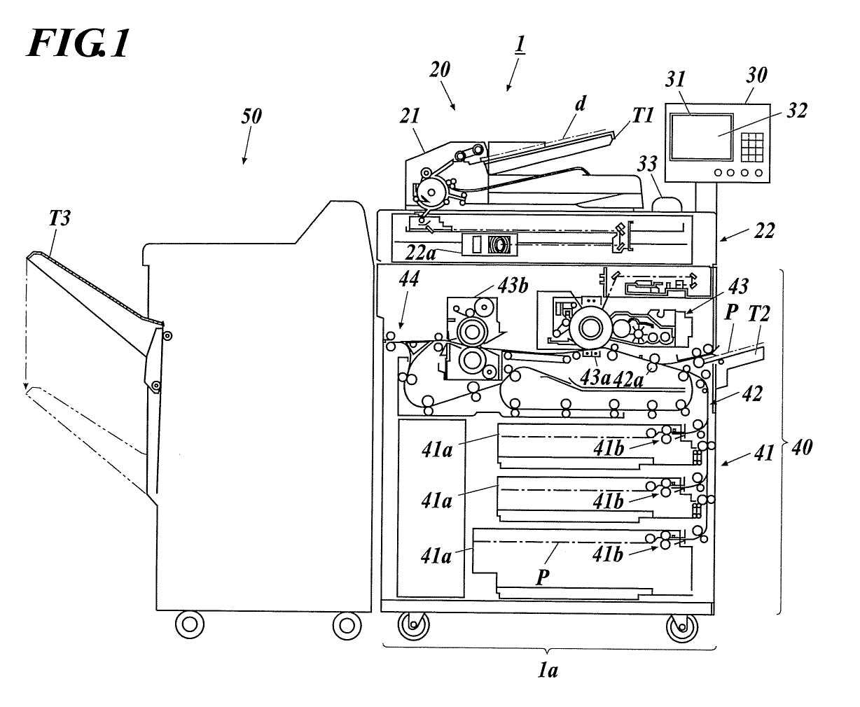

A schematic cross-sectional structure diagram of an image forming apparatus 1 of the embodiment is shown in FIG. 1.

As shown in FIG. 1, the image forming apparatus 1 is a digital multi function printer comprising a main body unit 1a, an after-process unit 50 to carry out after processes to a paper in which an image is formed and the like. The main body unit 1a reads an image from a document and forms the read image on a paper P. Further, the main body unit 1a receives page data including image data and job information of the job including setting information such as an image forming condition of each image data from an external device or the like, and forms the image on the paper P based on the received job information. The main body unit 1a comprises an image reading section 20, an operation display section 30, a print section 40 and the like.

The image reading section 20 comprises an automatic document feeding section 21 called the ADF (Auto Document Feeder) and a reading section 22. The image reading section 20 realizes the reading function of images of a plurality of documents based on the setting information which is received by the operation display section 30. The document d mounted on the document tray T1 of the automatic document feeding section 21 is conveyed to the contact glass which is a reading position. Then, the image on one side or on both sides of the document d is read by the optical system, and the image of the document d is read by the CCD (Charge Couple Device) 22a. Here, the image is not limited to image data such as diagrams, photographs and the like, and text data such as letters, symbols and the like are also included.

The data (analog image signal) of the image which is read by the image reading section 20 is output to the reading process section 140 of the after-mentioned image control substrate. After the data of the image is A/D converted and after various types of image processing are carried out in the reading process section 140, the data is output to the print section 40.

The operation display section 30 is constituted of the LCD (Liquid Crystal Display) 31, the touch panel 32 provided so as to cover the LCD 31 and a mouse 3, and of a group of operation keys (omitted from the drawing) in addition. The operation display section 30 receives an instruction from a user and outputs the operation signal of the instruction to the control section 110. Further, the operation display section 30 displays various types of setting screens, various types of process results and the like for inputting various types of operation instructions and setting information according to the display signal which is input from the control section 110.

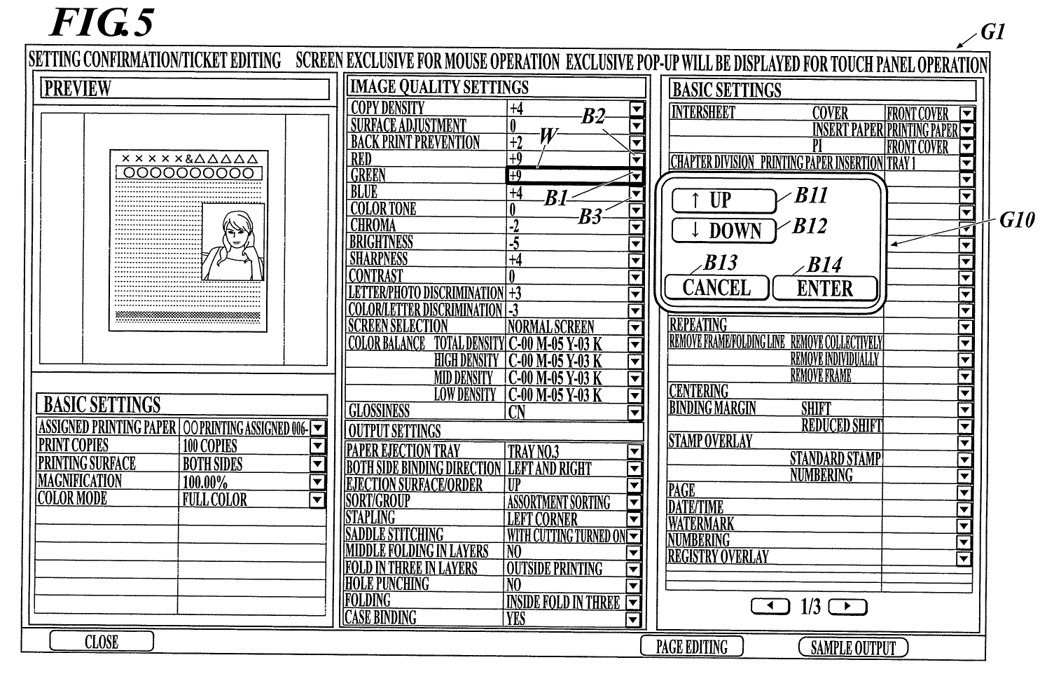

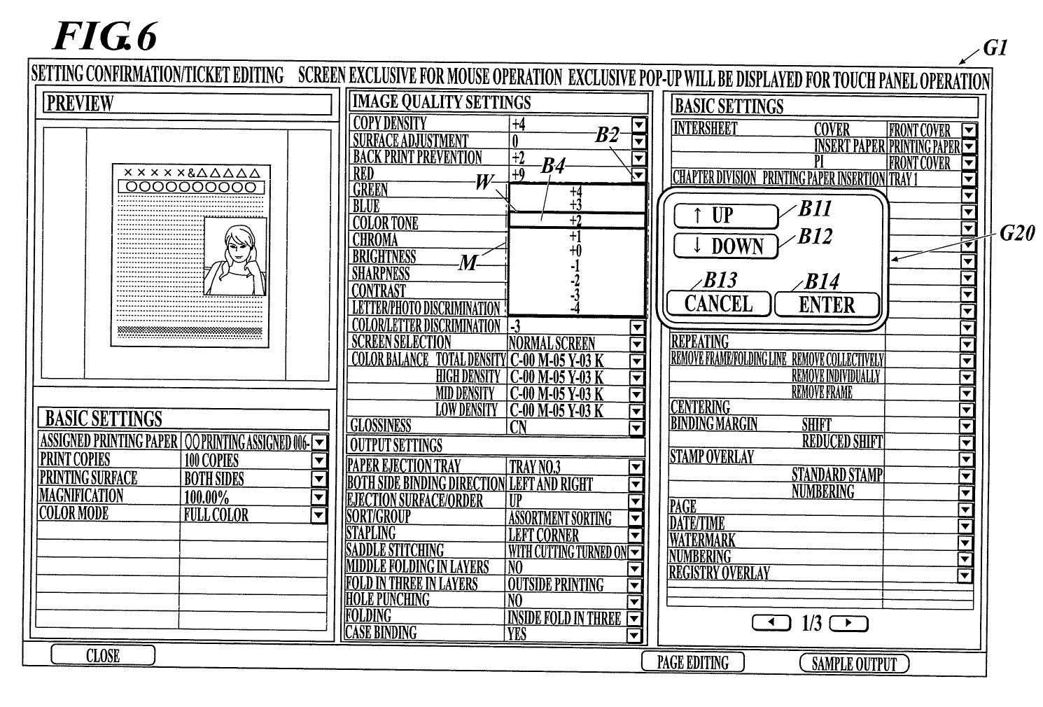

The LCD 31 functions as the operation screen (for example, see FIGS. 5 and 6) having a plurality of buttons showing various types of operation instructions and as the display section to display the after-mentioned operation supporting screen (see FIGS. 5 and 6). The LCD 31 outputs the operation signal indicating the instruction which is inputted in each screen to the after-mentioned control section 110.

Moreover, the touch panel 32 functions as the first input section which inputs the selecting instruction of the buttons on the operation screen based on the pushed signal on the operation screen. The mouse 33 has a different operation structure from the touch panel 32, that is, the mouse 33 functions as the second input section which inputs the selecting instruction of the buttons on the operation screen by an operation by a pointer which is displayed on the operation screen.

The print section 40 carries out the electrographic image forming process based on the inputted print data. The print section 40 comprises a paper feeding section 41, a paper feeding/conveyance section 42, an image forming section and a carry-out section 44.

The paper feeding section 41 comprises a plurality of paper feeding trays 41a, a paper feeding section 41b, a manual tray T2 and the like. The papers P which are identified according to paper types for each paper feeding tray 41b in advance are stored in the paper feeding tray 41a. The papers P which are housed in the paper feeding tray 41a are conveyed toward the paper feeding/conveyance section 42 one by one from the very top by the paper feeding section 41b. On the manual tray T2, various types of papers P can be loaded according to the needs of a user. The papers P which are loaded on the manual tray T2 are conveyed toward the paper feeding/conveyance section 42 one by one from the very top by the paper feeding roller.

The paper feeding/conveyance section 42 conveys the paper P which is conveyed from the paper feeding tray 41a or the manual tray T2 to a transfer device 43a via a plurality of intermediate rollers, a resist roller 42a and the like.

Further, the paper feeding/conveyance section 42 conveys the paper P in which the one-side image forming process is carried out to the both-side conveyance path by the conveyance path switching board and is again conveyed to the transfer device 43a via the intermediate rollers and the resist roller 42a.

The image forming section 43 comprises a photoconductor drum, a charging device, an exposure device having a laser output section to output a laser beam based on image data and a polygon mirror to move the laser beam in a main scanning direction, a development device, a transfer device 43a, a cleaning section and a fixing device 43b. The image forming section 43 realizes a function to form an image on a paper based on job information stored in the after-mentioned RAM 130.

In particular, an electrostatic latent image is formed by emitting a laser beam by the exposure device to the photoconductor drum which is charged by the charging device. Then, the development device develops the electrostatic latent image by attaching charged toner on a surface of the photoconductor drum on which the electrostatic latent image is formed. The toner image formed on the photoconductor drum by the developing device is transferred to the paper P in the transfer device 43a. Further, after the toner image is transferred to the paper P, the toner residual and the like on the surface of the photoconductor drum are removed by the cleaning section.

The fixing device 43b fixes the toner image transferred on the paper P which his conveyed by the paper conveyance section 42 by heat. The paper P in which the fixing process is carried out is conveyed to the after-process unit 50 from the outlet by being sandwiched by the paper-ejection rollers of the carry-out section 44.

The after-process unit 50 comprises an after-process unit and a paper ejection tray T3 on which the papers in which an image is formed by the main body unit 1a and the papers in which various types of after-processes are carried out are mounted. The after-process unit is constituted of a sorting section for carrying out the sorting process of the papers in which the image is formed, a punching section for carrying out the punching process, a stapling section for carrying out the stapling process to bind a bundle of papers at a set binding position, a folding section for carrying out the folding process, a cutting section for carrying out the cutting process and the like.

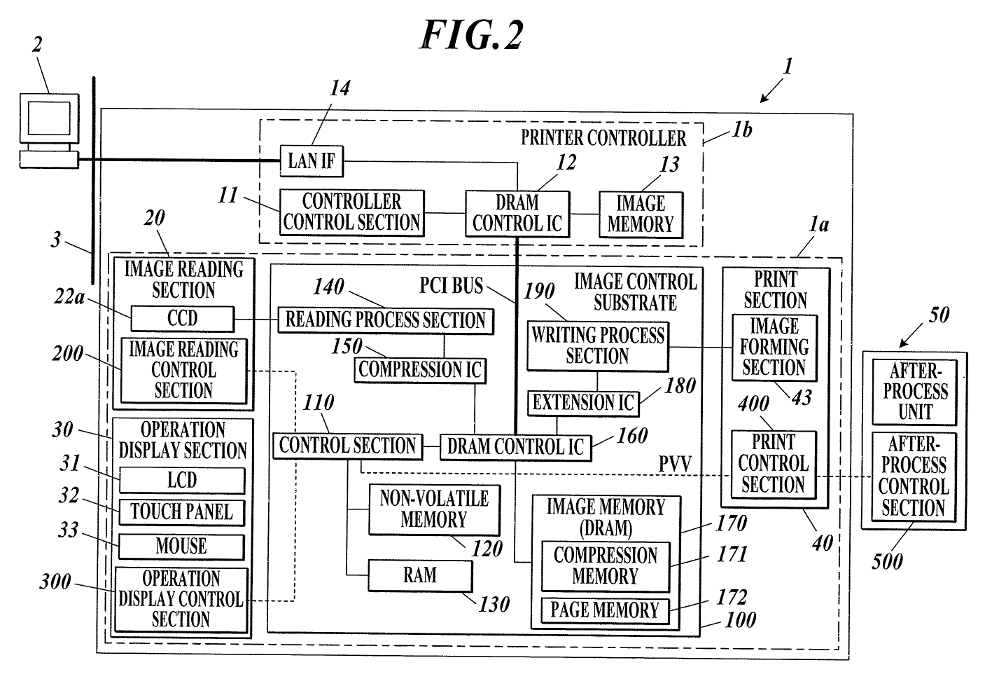

The control block diagram of the image forming apparatus 1 is shown in FIG. 2.

As shown in FIG. 2, the image forming apparatus 1 comprises the main body unit 1a, the printer controller 1b and the after-process unit 50 which is connected to the main body unit 1a. The image forming apparatus 1 is connected with the external device 2 on the network 3 via the LANIF (Local Area Network Interface) 14 of the printer controller 1b so as to carry out sending and receiving of information between one another.

The main body unit 1a comprises an image reading section 20, an operation display section 30, a printer section 40 and an image control substrate 100. Here, the same symbols are used for the structures which are same as each section described in FIG. 1, and the descriptions are omitted.

The image control substrate 100 comprises the control section 110, a non-volatile memory 120, the RAM (Random Access Memory) 130, a reading process section 140, a compression IC 150, the DRAM (Dynamic Random Access Memory) control IC 160, an image memory 170, an extension IC 180 and a writing process section 190.

The control section 110 comprises the CPU (Central Processing Unit) and the like. Further, the control section 110 reads the program which is specified among system programs and various types of application programs stored in the non-volatile memory 120, and expands the program in the RAM 130. Furthermore, the control section 110 carries out the concentrated control of each section of the image forming apparatus 1 by executing each of the processes by cooperating with the program expanded in the RAM 130.

For example, the control section 110 switches the mode between the copy mode, the printer mode and the scanner mode according to the instruction signal inputted from the operation display section 30 and the external device 2, and carries out the control of copying, printing, reading of image data and the like.

The control section 110 controls the following process by the operation supporting process program which is executed when the operation signal is input from the non-volatile memory 120 by the operation display section 30 according to the embodiment and by cooperating with the program and various types of data. The control section 110 determines whether the selecting instruction of a button in the operation screen (screen exclusive for mouse) which is structured so as to assume that the selecting instruction of the button is inputted by the mouse and which is displayed on the LCD 31 on the operation display section 30 is inputted by the touch panel 32 or not. When the selecting instruction is inputted by the touch panel 32, the control section 110 does not finalize the operation instruction which is indicated by the button to which the selecting instruction is given and the control section 110 controls the process for displaying the operation supporting screen which supports to input the selecting instruction in the LCD 31.

The non-volatile memory 120 stores the operation supporting process program according to the embodiment, data processed by various types of programs and the like in addition to various types of process programs and data according to the image forming.

The RAM 130 forms a work area which temporarily stores various types of programs executed by the control section 110, various types of data according to the programs and the like.

The reading process section 140 generates a digital image data, after carrying out various types of processes such as the analog process, the A/D conversion process, the shading process and the like to the analog image signal which is input from the image reading control section 200 of the image reading section 20. The generated image data is output to the compression IC 150.

The compression IC 150 carries out the compression process to the inputted digital image data and outputs to the DRAM control IC 160.

The DRAM control IC 160 controls the compression process of the image data by the compression IC 150 and the extension process of the compressed image data by the extension IC 180 according to the instruction from the control section 110 and also controls the input and output of the image data to and from the image memory 170.

For example, when it is instructed to save the image signal read by the image reading section 20, the DRAM control IC 160 makes the compression IC 150 execute the compression process of the image data inputted from the reading process section 140 and stores the compressed image data in the compressed memory 171 of the image memory 170. Further, when it is instructed to print output the compressed image data which is stored in the compressed memory 171, the DRAM control IC 160 reads the compressed image data from the compressed memory 171 and carries out the extension process by the extension IC 180 and stores in the page memory 172. Furthermore, when it is instructed to print output the image data stored in the page memory 172, the DRAM control IC 160 reads the image data from the page memory 172 and outputs to the writing process section 190.

The image memory 170 comprises the compression memory 171 and the page memory 172 which are constituted or the DRAM (Dynamic RAM). The compression memory 171 is a memory for storing the compressed image data. The page memory 172 is a memory for temporarily storing the image data (print data) for print output.

The extension IC 180 carries out the extension process to the compressed image data.

The writing process section 190 generates the print data for image forming based on the image data inputted from the DRAM control IC 160 and outputs the generated print data to the print section 40.

The image reading section 20 comprises the CCD 22a and the image reading control section 200 and the automatic document feeding section 21 and the reading section 22 shown in FIG. 1 (omitted from the drawing here) and the like. The image reading control section 200 controls the automatic document feeding section 21, the reading section 22 and the like to execute the light exposure scanning of the document surface and reads the image by making the CCD 22a carry out the photoelectric conversion to the reflection of the light. The read analog image signal is output to the reading process section 140.

The operation display section 30 comprises the LCD 31, the touch panel 32, the mouse 33, the operation display control section 300 and a group of operation keys such as ten keys and the like. The operation display control section 300 displays various types of screen for inputting various types of setting conditions, various types of process results and the like in the LCD 31 according to the display signal inputted from the control section 110. Further, the operation display control section 300 outputs the operation signal which is inputted from various types of switches, buttons, ten keys, operation key group, the touch panel 32 or the mouse 33.

The print section 40 comprises each section according to print output of the image forming section 43 and the like shown in FIG. 1 and the print control section 400. The print control section 400 controls the operation of each section of the print section 40 of the image forming section 43 and the like according to the instruction from the control section 110 and makes each section of the print section 40 carry out the image forming to the paper P based on the print data, which is inputted from the writing process section 190 and also outputs the instruction signal for operating each part of the after-process unit 50 to the after-process control section 500 according to the instruction from the control section 110.

In the after-process unit 50, various types of after-process units, the conveyance unit such as the conveyance roller which conveys the paper to various types of after-process units, the ejection tray T3 in which the paper conveyed from various types of after-process units is ejected and the like are provided. Various types of after-process units are integrally controlled by the after-process control section 500. The after-process control section 500 conveys the paper P to a predetermined after-process unit along the conveyance path according to the instruction signal of the after-process inputted from the control section 110 via the print control section 400 and the after-process control section 500 drive controls each section to carry out the predetermined after-process to the paper P and carries out the control to eject the paper in the paper ejection tray T3.

Next, each section of the printer controller 1b will be described. When the image forming apparatus 1 is used as a network printer, the printer controller 1b carries out administration and control of the job to be input to the image forming apparatus 1 from the external device 2 which is connected to the network 3. The printer controller 1b receives the data of the print target from the external device 2 and transmits the data to the main body unit 1a as a job.

The printer controller 1b comprises a controller control section 11, the DRAM control IC 12, the image memory 13 and the LAN IF 14.

The controller control section 11 integrally controls the operation of each section of the printer controller 1b and transmits the data inputted from the external device 2 to the main body unit 1a as a job via the LAN IF 14.

The DRAM control IC 12 controls the storing of the data received by the LAN IF 14 to the image memory 13 and the reading of data from the image memory 13. Further, the DRAM control IC 12 is connected with the DRAM control IC 160 of the image control substrate 100 by the PCI (Peripheral Components Interconnect) bus, and the DRAM control IC 12 reads the data of the print target from the image memory 13 and outputs to the DRAM control IC 160 according to the instruction from the controller control section 11.

The image memory 13 is constituted of the DRAM and temporarily stores the inputted output data.

The LAN IF 14 is a communication interface for connecting to the network 3 which is the LAN an the like such as the NIC (Network Interface Card), the modem and the like, and the LAN IF 14 receives data from the external device 2. The received data is outputted to the DRAM control IC 12.

Next, the operation carried out in the embodiment will be described.

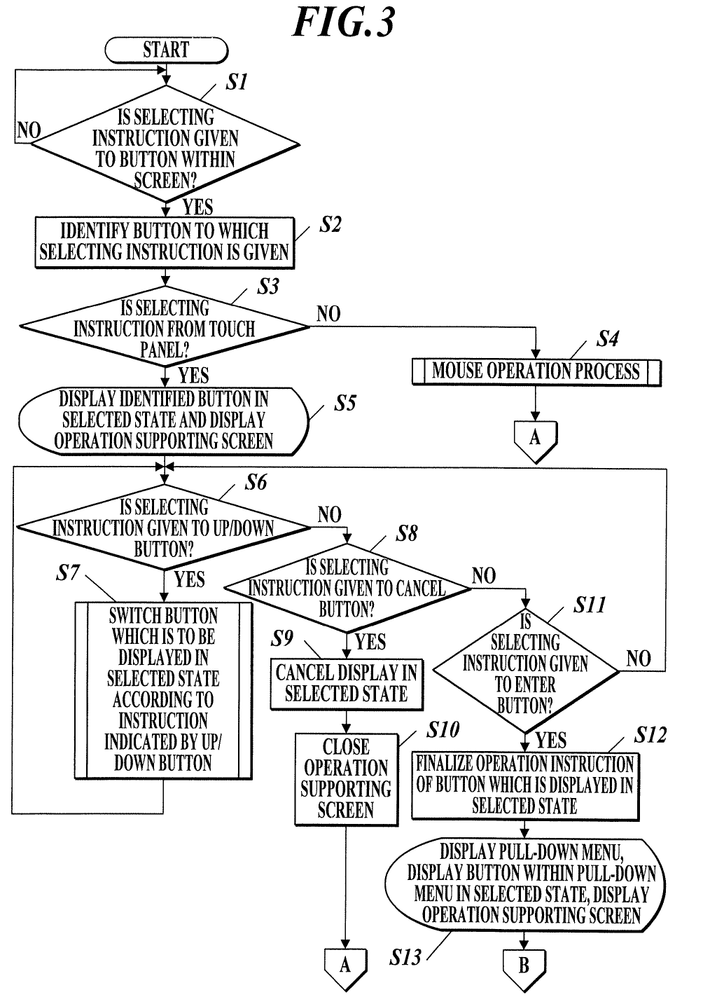

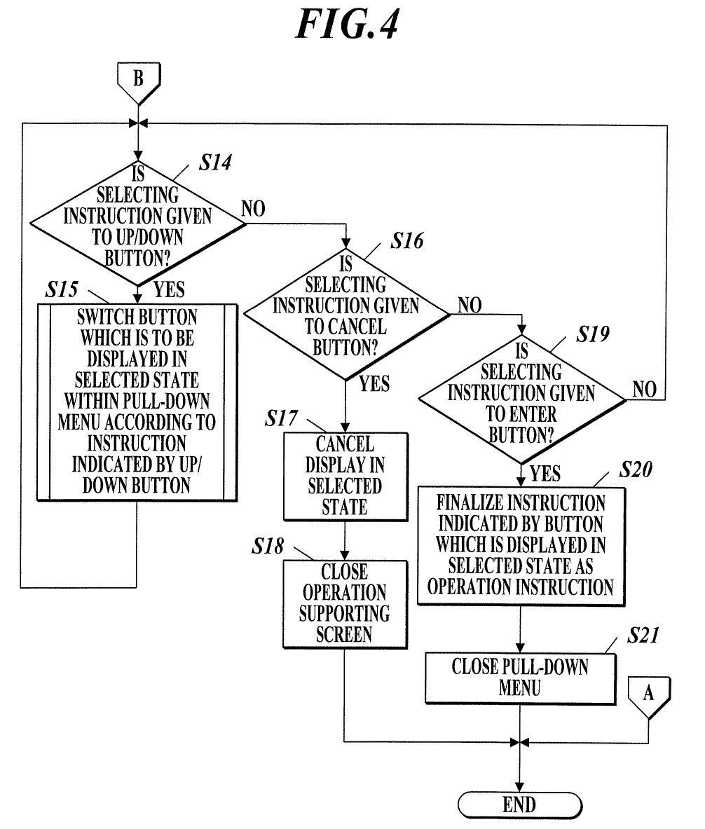

The flowchart of the operation supporting process of the embodiment is shown in FIGS. 3 and 4. The flowchart shown in FIGS. 3 and 4 is a process to be executed by the control section 110.

Here, the process is described by explaining a case where the operation screen (screen exclusive for mouse) which is structured so as to assume that the selecting instruction of the button is inputted by the mouse is displayed on the LCD 31 of the operation display section 30. The screen exclusive for mouse is a screen having a structure in which the buttons are in a size difficult to input the selecting instruction by the touch panel, for example, a size smaller than the size of finger tip.

The control section 110 determines whether a selecting instructing is given to a button within the operation screen displayed on the LCD 31 of the operation display section 30 or not (step S1). When the selecting instruction is not given to the button (step S1; No), the control section 110 returns to step S1.

When the selecting instruction is given to a button within the operation screen displayed on the LCD 31 of the operation display section 30 (step S1; Yes), the control section 110 identifies the button to which the selecting instruction is given based on the operation screen and the position coordinate signal on the operation screen to which the selection instruction is given (step S2).

The control section 110 determines whether the selecting instruction of the identified button is inputted from the touch panel 32 or not (step S3). As for the determining process in step S3, for example, it is determined whether the selecting instruction is a pushed signal from the touch panel 32 or not, or it is determined whether the selecting instruction is a click signal from the mouse 33 or not.

When the selecting instruction is not inputted from the touch panel 32 (step S3; No), the control section 110 executes the well known operation process of the mouse 33 which finalizes the operation instruction indicated by the button to which the selecting instruction is given (step S4), and the operation supporting process is finished.

When the selecting instruction is inputted from the touch panel 32 (step S3; Yes), the control section 110 displays the button (identified button) which is identified in the step S2 in a selected state and displays the operation supporting screen at a position so as not to cover and hide the identified button (step S5) without finalizing the operation instruction indicated by the button to which the selecting instruction is given.

Examples of the operation screen G1 and the operation supporting screen G10 in step S5 are shown in FIG. 5.

As shown in FIG. 5, the operation screen G1 is a screen exclusive to the mouse in which a plurality of buttons are displayed, and is a screen having a structure in which the buttons are in a size difficult for the selecting instruction to be inputted by the touch panel, for example, a size smaller than the size of finger tip.

In the operation screen G1, when the selecting instruction is given to the button (combo box) B1 corresponding to the green color of the image quality setting region from the touch panel, the button B1 is display as the identified button in a state being enclosed by a frame W and an indication showing that the button B1 is in the selected state is displayed.

Moreover, the operation supporting screen G10 is displayed at a position different from the button B1, that is, at a position which does not cover and hide the button B1. The operation supporting screen G10 includes an UP button B11, a DOWN button B12, a cancel button B13 and a enter button B14. The UP button B11 and the DOWN button B12 switch the selecting instruction of the button, that is, the UP button B11 and the Down button B12 functions as switching buttons which input the instruction to switch the button which is displayed in the selected state. The cancel button B13 functions as a cancel button which inputs the instruction to cancel the selecting instruction. The enter button B14 functions as a button to input an instruction to finalize the operation instruction which is indicated by the button to which the selecting instruction is given, that is, the button displayed in the selected state.

The control section 110 determines whether the selecting instruction of the UP button B11 or the DOWN button B12 is inputted after step S5 or not (step S6). When the selecting instruction of the UP button B11 or the DOWN button B12 is inputted (step S6; Yes), the control section 110 switches the button to be displayed in the selected state according to the selecting instruction of the UP button B11 or the DOWN button B12 (step S7).

As for the process of step S7, for example, the button to be displayed in the selected state is switched to the button B2 which corresponds to red which positions at upper side of the button B1 which corresponds to green when the selecting instruction of the UP button B11 is inputted in the operation screen G1 shown in FIG. 5 in which the button B1 corresponding to green is displayed in the selected state. Further, the process of step S7 switches the button to be displayed in the selected state to the button B3 corresponding to blue which is positioned at a lower side of the button B1 corresponding to green when the selecting instruction of the DOWN button B12 is inputted.

When the selecting instruction of the UP button B11 or the DOWN button B12 is not inputted (step S6; No), the control section 110 determines whether the selecting instruction of the cancel button B13 is inputted or not (step S8).

When the selecting instruction of the cancel button B13 is inputted (step S8; Yes), the control section 110 cancels the display indicating the selected state, for example, removes the frame W which indicates the selected state from the operation screen G1 (step S9) and closes the operation supporting screen G10 (step S10), and the operation supporting process is finished.

When the selecting instruction of the cancel button B13 is not inputted (step S8; No), the control section 110 determines whether the selecting instruction of the enter button B14 is inputted or not (step S11). When the selecting instruction of the enter button B14 is not inputted (step S11; No), the control section 110 returns to step S6.

When the selecting instruction of the enter button B14 is inputted (step S11; Yes), the control section 110 finalizes the operation instruction indicated by the button which is displayed in the selected state (step S12), displays the pull-down menu of the button, and displays any one of the buttons in the pull-down menu in the selected state. Further, the control section 110 displays the operation supporting screen of the button which is displayed in the selected state (step S13).

Examples of the operation screen G1 and the operation supporting screen G20 in step S13 are shown in FIG. 6.

The operation screen G1 shown in FIG. 6 is a screen in which the pull-down menu M of the button B2 is displayed when the selecting instruction of the enter button B14 is inputted from the touch panel while the button (combo box) B2 corresponding to red of the image quality setting region is in the selected state.

The button within the pull-down menu M which is set in advance, here, the Button B4 of “+2” is displayed so as to be enclosed by the frame W in the selected state, and the operation supporting screen G20 is displayed at a position which does not cover and hide the pull-down menu M. The operation supporting screen G20 has a similar structure as the operation supporting screen G10 which is shown and described in FIG. 5.

After step S13, the control section 110 determines whether the selecting instruction of the UP button B11 or the DOWN button B12 is inputted or not (step S14). When the selecting instruction of the UP button B11 or the DOWN button B12 is inputted (step S14; Yes), the control section 110 switches the button to be displayed in the selected state in the pull-down menu according to the selecting instruction of the UP button B11 or the DOWN button B12 (step S15).

When the selecting instruction of the UP button B11 or the DOWN button B12 is not inputted (step S14; No), the control section 110 determines whether the selecting instruction of the cancel button B13 is inputted or not (step S16).

When the selecting instruction of the cancel button B13 is inputted (step S16; Yes), the control section 110 cancels the display indicating the selected state, for example, removes the frame W which indicates the selected state from the operation screen G1 (step 17) and closes the pull-down menu M and the operation supporting screen G10 (step S18), and the operation supporting process is finished.

When the selecting instruction of the cancel button B13 is not inputted (step S16; No), the control section 110 determines whether the selecting instruction of the enter button B14 is inputted or not (step S19). When the selecting instruction of the enter button B14 is not inputted (step S19; No), the control section 110 returns to step S14.

When the selecting instruction of the enter button B14 is inputted (step S19; Yes), the control section 110 finalizes the operation instruction indicated by the button which is displayed in the selected state (step S20) and closes the pull-down menu of the button (step S21), and the operation supporting process is finished.

As described above, according to the embodiment, when the selecting instruction is inputted by the touch panel in the operation screen (screen exclusive for mouse) which is structured so as to assume that the operation instruction of the button is inputted by the mouse, the selecting instruction can be supported by the displayed operation supporting screen without finalizing the operation instruction indicated by the button to which the selecting instruction is given. Therefore, the operation can be improved by avoiding an error operation in the touch panel in the screen exclusive for mouse, that is, the operation screen which is not structured so as to assume that the operation instruction of the button is inputted by the touch panel.

Moreover, the operation can be improved because the selecting instruction of a button can be switched to another button, the operation instruction indicated by the button to which the selecting instruction is given can be finalized and can be canceled by the operation supporting screen having the UP button 11, the DOWN button 12, the cancel button 13 and the final button 14.

Furthermore, because the operation supporting screen can be displayed at the position different from the position of the button to which the selecting instruction is given, the operation in the operation supporting screen can be carried out by visually recognizing the button to which the selecting instruction is given and the operation supporting screen without covering and hiding the button to which the selecting instruction is given with the operation supporting screen. Therefore, the operation can be improved.

In the above description, an example in which the non-volatile memory 120 is used as a computer readable medium of the computer according to the embodiment is described. However, the present invention is not limited to this example. As for another computer readable medium, the non-volatile memory such as a flash memory and a portable recording medium such as the CD-ROM may be applied. Further, a carrier wave is applied in the present invention as a medium which provides data, of the program according to the present invention via the communication circuit.

Moreover, the present invention is not limited to the content of the above embodiment, and changes can be arbitrarily made within the scope of the invention.

According to an aspect of the preferred embodiment of the present invention, an image forming apparatus comprises a display section to display an operation screen having a plurality of buttons each of which shows each type of operation instruction, a first input section to input a selecting instruction of at least any one button among the buttons based on a, pushed signal on the operation screen, a second input section to input the selecting instruction of the one button by a structure different from the first input section and a control section to make the display section display an operation supporting screen which supports to input the selecting instruction without finalizing an operation instruction indicated by the one button to which the selecting instruction is given when the selecting instruction is input by the first input section in the operation screen which is structured so as to assume that the selecting instruction of the one button is inputted by the second input section.

In the image forming apparatus, when the selecting instruction is inputted by the first input section in the operation screen which is structured so as to assume that the operation instruction of the button is inputted by the second input section, the selecting instruction can be supported by the displayed operation supporting screen without finalizing the operation instruction indicated by the button to which the selecting instruction is given. Therefore, an error operation in the first input section in the operation screen which is structured so as to assume that the operation instruction of the button is inputted by the second input section, that is, the operation screen which is not structured so as to assume that the operation instruction of the button is inputted by the first input section is prevented. Therefore, the operability can be improved.

Preferably, the operation supporting screen includes a switching button to switch a button to which the selecting instruction is given to another button from the one button.

Moreover, because the button to which the selecting instruction is given can be switched to one button to another button by the operation supporting screen, the operability can be improved.

Preferably, the operation supporting screen further comprises a cancel button to cancel the selecting instruction and an enter button to finalize the operation instruction indicated by the one button to which the selecting instruction is given.

Moreover, because the operation instruction indicated by the button to which the selecting instruction is given can be finalized or can be canceled by the operation supporting screen, the operability can be improved.

Preferably, the control section displays the operation supporting screen at a position which is different from a position of the one button to which the selecting instruction is given.

Moreover, the operation supporting screen can be displayed at the position different from the position of the button to which the selecting instruction is given, the operation in the operation supporting screen can be carried out by visually recognizing the button to which the selecting instruction is given and the operation supporting screen without covering and hiding the button to which the selecting instruction is given by the operation supporting screen. Therefore, the operability can be improved.

Preferably, the first input section is a touch panel, the second input section is a mouse, and the operation screen is a screen which is structured so as to assume that the selecting instruction of the one button is inputted by the mouse.

Moreover, the error operation in the touch panel in the operation screen which is not structured so as to assume that the operation instruction of the button is inputted by the touch panel can be avoided. Therefore, the operability can be improved.

The present U.S. patent application claims a priority under the Paris Convention of Japanese patent application No. filed on Jan. 11, 2008, which shall be a basis of correction of an incorrect translation.

What is claimed is:

1. An image forming apparatus, comprising:
a display section to display an operation screen having a plurality of buttons each of which shows each type of operation instruction;
a first input section to input a selecting instruction of at least any one button among the buttons based on a pushed signal on the operation screen;
a, second input section to input the selecting instruction of the one button by a structure different from the first input section; and
a control section to make the display section display an operation supporting screen which supports to input the selecting instruction without finalizing an operation instruction indicated by the one button to which the selecting instruction is given when the selecting instruction is input by the first input section in the operation screen which is structured so as to assume that the selecting instruction of the one button is inputted by the second input section.

2. The image forming apparatus of claim 1, wherein the operation supporting screen includes a switching button to switch a button to which the selecting instruction is given to another button from the one button.

3. The image forming apparatus of claim 2, wherein the operation supporting screen further comprises a cancel button to cancel the selecting instruction and an enter button to finalize the operation instruction indicated by the one button to which the selecting instruction is given.

4. The image forming apparatus of claim 1, wherein the control section displays the operation supporting screen at a position which is different from a position of the one button to which the selecting instruction is given.

5. The image forming apparatus of claim 1, wherein
the first input section is a touch panel,
the second input section is a mouse, and
the operation screen is a screen which is structured so as to assume that the selecting instruction of the one button is inputted by the mouse.
